(19) United States
(12) Patent Application Publication
(10) Pub. No.: US 2023/0000030 A1
(43) Pub. Date: Jan. 5, 2023

(54) STORAGE, GROWING SYSTEMS AND METHODS

(71) Applicant: Jones Food Company Limited, Scunthorpe (GB)

(72) Inventors: Andrew INGRAM-TEDD, Hatfield, Herts (GB); Matthew WHELAN, Hatfield, Hertfordshire (GB); Lars Sverker Ture LINDBO, Hatfield, Hertfordshire (GB); James LLOYD-JONES, Hatfield, Hertfordshire (GB)

(73) Assignee: Jones Food Company Limited, Scunthorpe (GB)

(21) Appl. No.: 17/783,583

(22) PCT Filed: Dec. 8, 2020
(86) PCT No.: PCT/EP2020/085106

§ 371 Date: Jun. 8, 2022

(30) Foreign Application Priority Data
Dec. 9, 2019 (GB) 1918018.1

(51) Int. Cl. A01G 31/06; A01G 7/04; G05B 19/416

(52) U.S. Cl. CPC A01G 31/06; A01G 7/045; G05B 19/416; A01G 2031/006

(57) ABSTRACT

A pole system for racking, storing, germinating, propagating and growing living organisms on a growth tray, the pole system including: a substantially vertical support structure, the support structure including at least one utility system for supporting propagation or growth of a living organism; one or more vertically-spaced interface positions, each for interfacing with a growth tray; and one or more openings in the support structure, corresponding to one or more of the interface positions, for providing services to interfaced growth tray(s) is disclosed. Further, a hydroponic system and method using the pole system are disclosed.

The present invention relates to storage systems. More specifically but not exclusively the present invention relates to storage systems for growing living organisms.

Conventional systems and methods for growing certain crops are well known. Most require large areas of land and need to be positioned in appropriate locations for the conditions required for the crops to be grown.

More recently, advanced farming techniques such as hydroponics have led to the ability to grow high quality crops indoors with very high utilisation of lighting, water and fertiliser. However, these systems have been less efficient in terms of land use, capital and labour.

The present disclosure describes systems and methods for improving the efficiency of these types of techniques.

Some commercial and industrial activities require systems that enable the storage and retrieval of a large number of different products. One known type of system for the storage and retrieval of items in multiple product lines involves arranging storage containers or containers in stacks on top of one another, the stacks being arranged in rows. The storage containers or containers are accessed from above, removing the need for aisles between the rows and allowing more containers to be stored in a given space.

Methods of handling containers stacked in rows have been well known for decades. In some such systems, for example as described in U.S. Pat. No. 2,701,065, to Bertel comprise free-standing stacks of containers arranged in rows in order to reduce the storage volume associated with storing such containers but yet still providing access to a specific container if required. Access to a given container is made possible by providing relatively complicated hoisting mechanisms which can be used to stack and remove given containers from stacks. The cost of such systems are, however, impractical in many situations and they have mainly been commercialised for the storage and handling of large shipping containers.

The concept of using freestanding stacks of containers and providing a mechanism to retrieve and store specific containers has been developed further, for example as described in EP 0 767 113 B to Cimcorp. EP'113 discloses a mechanism for removing a plurality of stacked containers, using a robotic load handler in the form of a rectangular tube which is lowered around the stack of containers, and which is configured to be able to grip a container at any level in the stack. In this way, several containers can be lifted at once from a stack. The movable tube can be used to move several containers from the top of one stack to the top of another stack, or to move containers from a stack to an external location and vice versa. Such systems can be particularly useful where all of the containers in a single stack contain the same product (known as a single-product stack).

In the system described in EP'113, the height of the tube has to be as least as high as the height of the largest stack of containers, so that that the highest stack of containers can be extracted in a single operation. Accordingly, when used in an enclosed space such as a warehouse, the maximum height of the stacks is restricted by the need to accommodate the tube of the load handler.

EP 1037828 B1 (Autostore) the contents of which are incorporated herein by reference, describes a system in which stacks of containers are arranged within a frame structure. Robotic load handling devices can be controllably moved around the stack on a system of tracks on the upper most surface of the stack.

Other forms of robotic load handling device are further described in, for example, Norwegian patent number 317366, the contents of which are incorporated herein by reference.

A further development of load handling device is described in PCT publication WO 2015/019055 A1 (Ocado Innovation Limited) where each robotic load handler only covers one grid space, thus allowing higher density of load handlers and thus higher throughput of a given size system.

In such known storage systems a large number of containers are stacked densely. The containers are conventionally used to store goods to supply online grocery orders picked by robots.

Storage systems are known to be used for growing living organisms using hydroponic methods. As mentioned above, but now in more detail, hydroponics is a method of growing plants without soil by instead using mineral nutrient solutions in a water solvent. Plants typically grown in soil or land may be grown with their roots exposed to the nutritious liquid, or the roots may be physically supported by a medium such as perlite, Rockwool™, vermiculite, coco fibre, sand or gravel. The nutrients used in hydroponic systems can come from an array of different sources. The delivery frequency of neutriants is governed by parameters such as plant size, plant growing stage, climate, substrate, and substrate conductivity, pH, and water content.

In connection with growing crops for consumptions, pyrrolizidine alkaloids (PAs) are a group of chemicals that can be naturally occurring in plants as a defence mechanism against insects, other pests or microbiological hazards. Some PAs exhibit hepatotoxicity that is damaging to the liver. Therefore PAs may be subject to regulation in food and particularly in herbs and medicines because a build-up of these chemicals in the body can represent a health risk. PAs can be particularly prevalent in crops such as medicinal herbs so there is a need to minimise the level of PAs found in crops.

In hydroponic growing systems the quantity of water required to grow a crop to harvest is greatly reduce compared with soil-based agriculture. In a run-to-waste system, sometimes referred to as “The Bengal System”, nutrient and water solution is periodically applied to the medium surface. Nutrient-rich waste may be collected and re-used in the system.

A development of a growing system and method is described in PCT publication WO2016/166311A1 (Ocado Innovation Limited) where plants are grown in containers and the containers are stored in stacks. Within individual containers, services are provided for enabling plants to grow. Load handing devices are used to take containers from the stack and deposit them in alternative locations.

UK application GB1911505.4 (Ocado Innovation Limited) “Hydroponics Growing System and Method” disclose another hydroponic growing system. Seeds are pre-treated and germinated in a ‘high-care’ portion to reduce contamination during germination. Seedlings are then moved to a growing room in support vehicles containing growing trays move along a frame or rack as the crop grows and until the crop is ready for harvesting. The system disclosed includes illumination apparatus above each growing station, and a recirculating irrigation system for providing nutrients to a growing crop. The irrigation system uses mains water blended with nutrients, which is pumped to the growing crop. Water which drains from the racks is reintroduced to the water blend to minimise waste water.

The present invention aims to further develop the systems and methods of growing living organisms or crops. An aim of the present invention is to maximise the quality and yield of the crop. Further, an aim of the present invention is to improve efficiency in terms of use of assets, resources and services required by the crop.

### SUMMARY

Aspects of the invention are set out in the accompanying claims.

A hydroponic system and pole system for racking, storing, propagating and growing living organisms on a growth tray are disclosed.

The pole system comprises: a substantially vertical support structure, the support structure including at least one utility system for supporting propagation or growth of a living organism; one or more vertically-spaced interface positions, each for interfacing with a growth tray; and one or more openings in the support structure, corresponding to one or more of the interface positions, for providing services to interfaced growth tray(s).

The pole system replaces a traditional rack system. Thus, relatively little equipment and or framework is required to rack, store, propagate and grow living organisms. The interfaced positions may not include “hard” or physical connections or connectors. Thereby the pole system minimises the amount of equipment required to be clean in order to maintain a high-care environment, and reduces the associated costs of cleaning. Further, fewer assets are required to set-up a hydroponic system. By reducing the amount of cleaning it is easier to maintain a high-care clean facility. It follows that the crop is subjected to fewer attacks from insects, other pests and microbiological hazards. As a result a stronger crop with lower of negligent levels PAs may be produced.

The at least one utility system may comprise one or more of: a fluid delivery system; a fluid drain system; a fluid recirculation system; an air control system; a temperature control system; a power system; and a control system. The at least one utility may be supported on, integrated with or at least partially encased by the support structure.

Thus, the pole system may provide one, some or all of the utilities required for propagating and growing living organisms in a controlled environment, ensuring uniformity of the crop and consistency of quality.

The control system may comprise one or more of: communication interface(s) for relaying data to and from the pole system; a central control system in communication with the pole system for managing conditions of a growth tray interfaced with the pole system; inductive coils corresponding to interface position(s) for relaying power and control signals to a growth tray interfaced with the pole system; and sensors corresponding to interface position(s) for sensing the presence of a growth tray interfaced with the pole system, and monitoring conditions of a growth tray interfaced with the pole system.

The communication interface may comprise an optical wireless communication interface. For example, the optical wireless interface may be a Li-Fi (light fidelity) wireless interface. Li-Fi systems are capable of transmitting data at high speeds over visible light, ultraviolet and infrared spectrums. Typically, optical wireless interfaces use light from LEDs. It will be appreciated that Li-Fi does not require a physical connection. Using Li-Fi has the advantage of avoiding potential interference with or from other electromagnetic interfaces. The spectrum of light used for communication may be selected to be outside the spectrum required for growth of the living organisms.

Alternatively, the communication interface may comprise a Wi-Fi interface. It will be appreciated that Wi-Fi does not require a physical connection.

The communication interface may transmit data and between a growth tray and the pole system. Further, the communication interface may transmit data between the pole system and the central control system.

Thus, the central control system may monitor and control each tray. The monitoring and control decisions may be done remotely from the location of the pole system, thereby avoiding the need for a technician to be present in the volume. Data, including control instructions, may be transferred to and from the pole wirelessly. In this way, previously manual operations may become more automated and more efficient.

Further, the control system may control the at least one utility system. In this way, the control system may control the environmental conditions of each tray.

The control system may be at least partially integrated into the pole system and or growth tray(s). For example, each growth tray may include a camera to monitor a growing crop. The camera information may then be relayed to the central control system to be used with machine learning or AI technology to determine and administer optimum growth conditions for the crop via feedback to the pole system and control of other utilities included in the pole system. As a result real-time data logging of the conditions of each growth tray, may provide a significant advantage of crop monitoring and production. Further, as each growth tray may be individually traced and tracked within a hydroponic facility, consistency between crops may be improved—for example using identification means such as RFID tags. Still further, sensors may be embedded within the trays making a ‘smart’ tray. For example, sensors may comprise one or more sensors for detecting the temperature of the air, the relative humidity, the concentration of CO₂, the pH, temperature, concentration and or electrical conductivity of the nutrient fluid, one or more cameras, the air flow rate, for the air pressure, fluid volume and flow rate through values etc.

The communication interface(s) may comprise: an end cap for inserting in the uppermost end of the support structure. This assists in having a clear line of sight to each of the poles in the system to a communication hub located near the ceiling, for example. In some arrangements, a communication interface panel may be located proximal to the base of the support structure. For example, this may be specifically for controlling fluid pumps or air-flow. Other communication interfaces may be arranged for specific trays and or for specific uses.

The fluid delivery system may comprise: at least one fluid delivery pump for pumping fluid to each of the interface positions via a pipe extending substantially vertically up the support structure; and the one or more openings comprise a fluid outlet for delivering fluid to an interfaced tray. The fluid drain system may comprise: a pipe extending substantially vertically down the support structure for receiving fluid run-off from growth tray(s) interfaced with the pole system via an opening in the support structure comprising a fluid inlet; and at least one fluid drain pump for relaying fluid run-off to the fluid recirculating system.

Thus, the fluid delivery, drain and recirculation systems are substantially closed or self-contained thereby minimising the risk of contamination or introduction of hazards. This contributes to the reduction of fluid required to produce the crop and as a result improved resource usage and efficiency. Further, the length of the drainage system may be minimised thereby reducing the amount of equipment that requires regular cleaning. Still further, nutrients which are not absorbed by the crop may be recycled into the fluid delivery system, thereby minimising use of resources.

At least one of the one or more openings in the support structure may comprise air vent(s) of the air control system for circulating humid and temperature controlled air to interfaced growth tray(s). These help to maintain an optimised growing environment for the crop at each stage of its life-cycle.

The support structure may be inserted in a floor. For example, the pole drainage system may link directly to a main drain in the floor for recycling fluid, thereby maintaining a substantially closed system and again thereby minimising the length of additional piping and channels in the system.

The pole system may further comprise: a base support comprising: a frame extending radially from the lower end of the support structure to provide stability to the support structure and having at least one drainage channel for conducting run-off from growth tray(s) interfaced with the pole system to the fluid drain or recirculation systems. The base support may further comprise a locating member, for locating an interfaced growth tray. The base support assists in the structural stability of the pole system.

The base support may further comprise fluid, drain or power connections. Aspects of the drainage system and recirculation system may be integrated in the base support. Again, minimising surfaces that may require cleaning and minimising the amount of equipment overall.

Growth tray(s) for use with the pole system may comprise: a fluid inlet for receiving fluid from the pole system and delivering fluid to a growing surface, and a fluid outlet for delivering fluid run-off to the pole drain system. A stack of growth trays may be interfaced with the pole system, and the trays may comprise support legs at least at each corner. The bottom-most support leg in the stack may locate in the locating member and the support leg may comprise a down-pipe for transmitting run-off from above-stacked growth trays. Growth tray(s) may receive power from the pole system for illuminating lights arranged on the lower face of the growth tray(s). Each growth tray may comprise identification means.

Thus, growth trays may be provided for use with the pole system that are adapted to interface with the pole system so that the system works efficiently. Identification of growth trays may assist in operating the control system to rack location of and services provided to the growth trays.

In use, the lower or bottom-most growth tray foot attaches to the drain point on the lowest fixed area “stand” of the smart pole. When in position further growth trays can be stacked on top of each adjacent-below growth tray ascending the smart pole. The growth tray(s) may not be “locked” or physically attached to the interface positions, rather the growth tray(s) may merely touch the support structure for receiving the utilities from the pole system, or even have no physical contact with the pole system, rather be positioned proximal to the pole system for receiving utilities. In other arrangements, the trays may be hooked on to the pole.

Utilities may be delivered directly to the growth tray(s). Within the facility or system, each tray is individually traced and monitored, regardless of whether a single growth tray is stacked adjacent to the pole system or whether there is a full stack of growth trays, occupying each of the interface positions.

In use, up to four stacks of growth trays may be arranged around the pole system and interface with the pole system at each vertically-spaced level. Growth trays may be simply dropped down into position. The position of growth trays may be determined by the control system in order to ensure that the support poles remain balanced with an evenly distributed load where trays are physically attached to the support poles. Further, trays requiring similar environmental conditions may be located proximate to each other so that services may be delivered efficiently.

The hydroponic system may comprise support poles arranged in a high-care portion of the hydroponic system. The poles may be arranged in rows providing pathways therebetween allowing access to each of the poles and to each of the growth trays supported or interfaced thereon. The trays may be moved within the system manually or using one or more automated load handling device. The system may be substantially closed, thus maintaining the high-care portion of the system.

Further, a method of producing a crop having reduced or substantially negligible Pyrrolizidine Alkaloids, PAs, wherein the crop is provided with services via the smart pole system, and the crop is germinated, propagated or grown in a high-care portion of the hydroponic system.

In this way, the present invention addresses some of the problems of the prior art and provides a method and system of increasing the efficiency or yield of a hydroponic growing system. The invention will now be described with reference to the accompanying diagrammatic drawings in which:

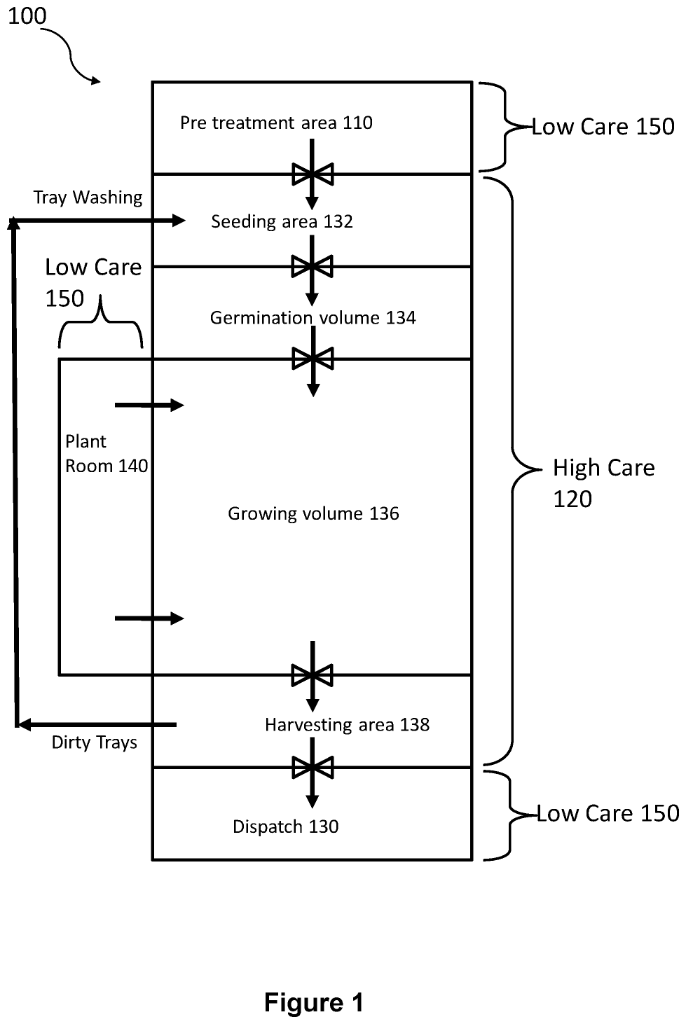

FIG. 1 is a schematic diagram showing an overview of a hydroponic growing system;

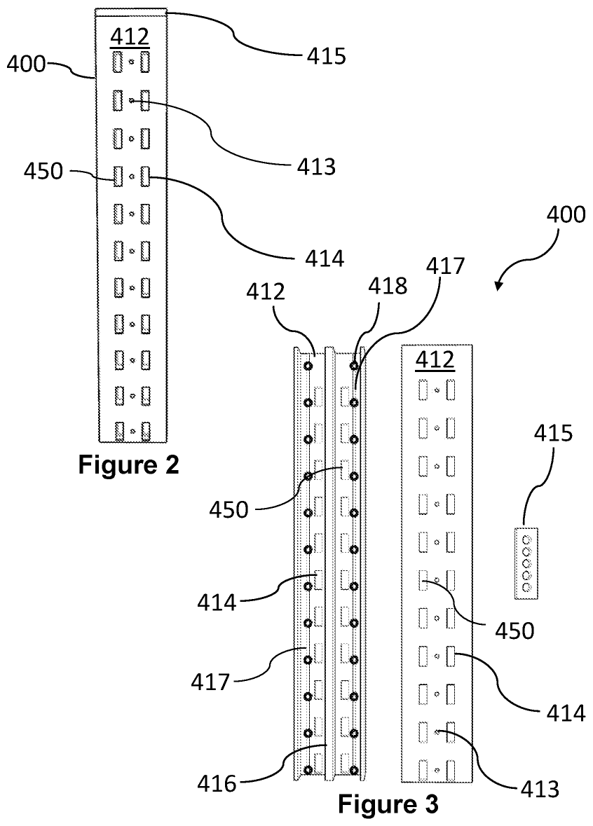

FIG. 2 shows a smart pole according to one embodiment;

FIG. 3 shows a deconstructed smart pole of the type shown in FIG. 2;

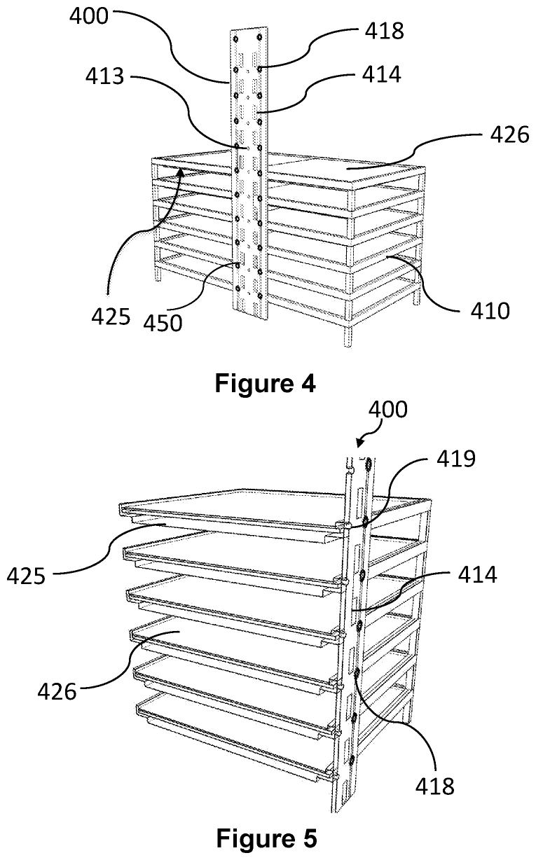

FIG. 4 shows a stack of growth trays interfaced with a smart pole of the type shown in FIGS. 2 and 3;

FIG. 5 shows a section through the interface between the smart pole of the type shown in FIGS. 2-4 and a stack of growth trays in more detail;

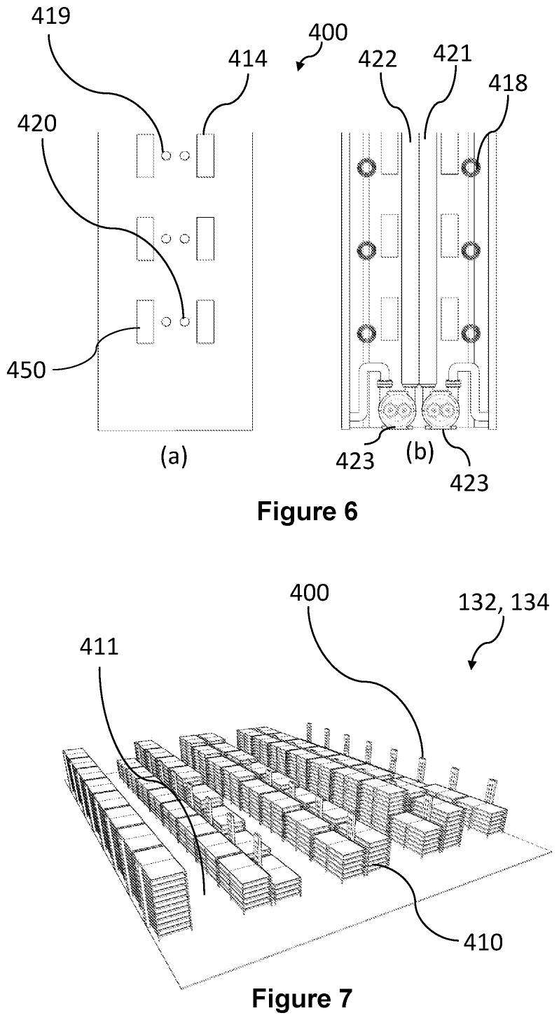

FIGS. 6 (a) and (b) show the inside and outside of the bottom or lower-most section of a smart pole of the type shown in FIGS. 2-5;

FIG. 7 shows a number of smart poles arranged in a high-care facility, each having stacks of growth trays arranged around them and in rows;

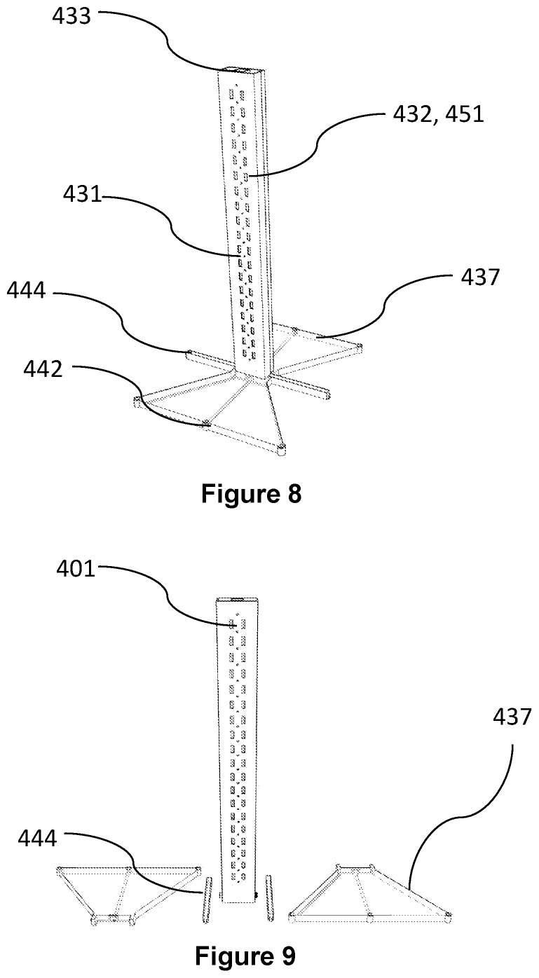

FIG. 8 shows a smart pole according to another embodiment;

FIG. 9 shows a deconstructed smart pole of the type shown in FIG. 8;

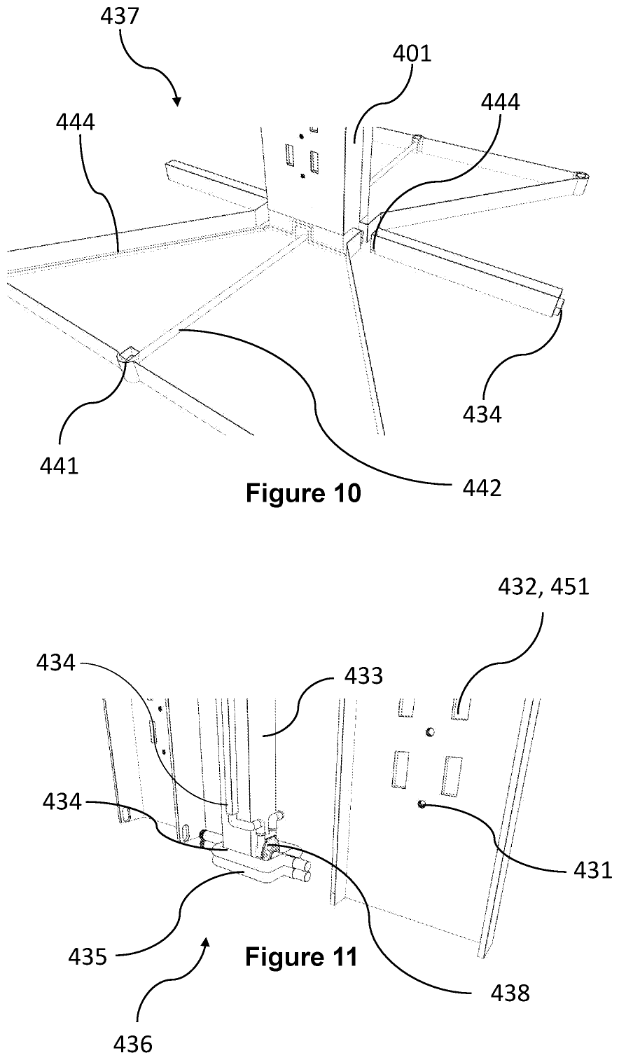

FIG. 10 shows a partially deconstructed base and lower section of a smart pole of the type shown in FIGS. 8 and 9;

FIG. 11 shows the inside and outside of the bottom or lower-most section of a smart pole of the type shown in FIGS. 8-10;

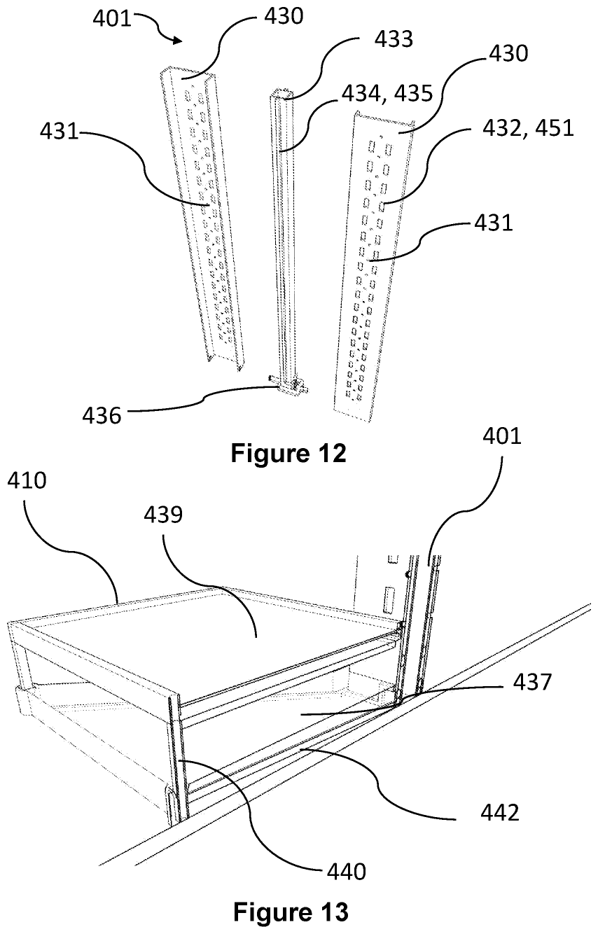

FIG. 12 shows a deconstructed smart pole of the type shown in FIGS. 8-11;

FIG. 13 shows a section through the interface between the smart pole of the type shown in FIGS. 8-12, and a growth tray; and

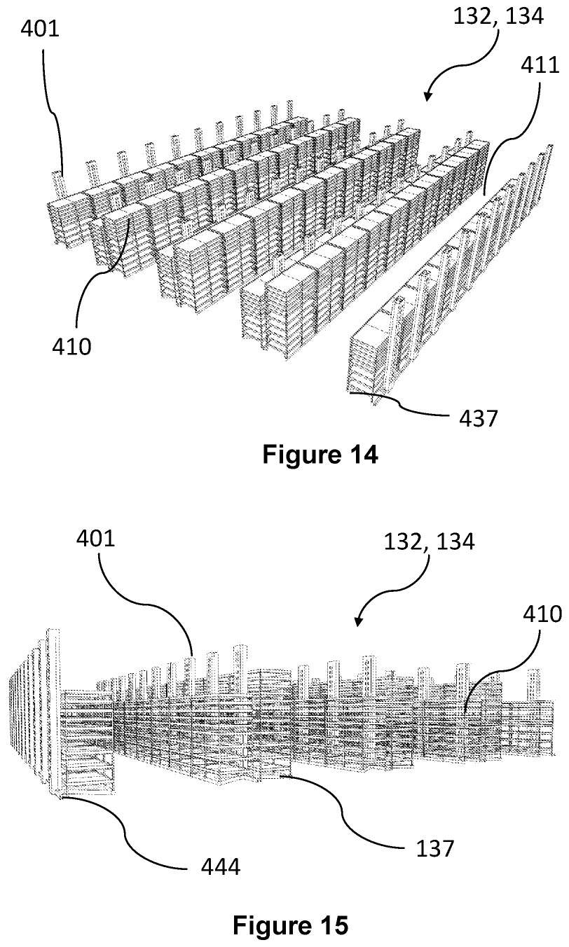

FIGS. 14 and 15 shows a number of smart poles arranged in a high-care facility, each having stacks of growth trays arranged around them and in rows.

The present invention forms a part of a larger hydroponic growing system. It will be appreciated that the larger system described herein is exemplary only, and other combinations and configurations of the apparatus and equipment described are anticipated by the inventors of the present disclosure without departing from the scope of the invention described herein.

The larger hydroponic growing system 100 comprises a system in which crucial parts of the system 100 comprise a ‘high-care’ environment. A high-care environment is defined as an area requiring high levels of hygiene, careful and clean working practices, fabrication, and the design of facilities and equipment to minimise product contamination with regard to microbiological hazards. Generally speaking products produced in high-care areas will have undergone a process to reduce any microbiological contamination prior to entering the high-care area.

In hydroponic growing systems, the concept of high-care environments has not been fully utilised. Contamination in the absence of such a high-care environment can lead to reduction in yield of a given crop, infestation requiring sanitisation of a significant volume of the growing chamber or loss of a given crop entirely. Further, crops may have a higher level of PAs.

As illustrated in the schematic diagram of FIG. 1, the hydroponic growing system 100 may comprise a seed and equipment pre-treatment area 110, a high-care portion 120 and a dispatch portion 130.

The seed and equipment pre-treatment area 110 may comprise hot water treatment means, UVC treatment means and in the case of the seeds, may comprise agitation means. The high-care portion 120 may comprise a seeding area 132, a germination volume 134, a growing volume 136, and a harvesting area 138.

The high-care portion 120 of the hydroponic growing system 100 may comprise equipment designed, treated and installed so as to assist in the maintenance of a high-care environment for seeding, germinating, growing and harvesting crops of any variety.

In order to assist with cleaning equipment located within the high-care portion 120, the equipment is preferably raised off the floor enabling easier and more effective cleaning of the equipment and floor. Further, all uprights of apparatus and where possible as much of the equipment in the high-care portion 120 of the system 100 as possible is painted or treated with antimicrobial paint such as, for example, paint comprising silver. For instance, the walls, floor and ceiling of the high-care portion 120 of the hydroponic growing system 100 are painted white to enable visual checks of the overall cleanliness of the growing system 100.

To assist with preventing contamination by water borne contaminants, preferably the amount and length of drainage system is reduced. Further this may assist with enabling regular deep cleaning of the whole system 100.

It will be appreciated that ethylene may be produced in the germination and growing volumes 134, 136 of the system 100 and this ethylene can stimulate decomposition in fresh or growing produce. Thus, it is vital that where unprocessed produce is held in storage, ethylene is controlled, to ensure that the freshness is preserved and that waste from the process is minimised. Preferably, the high-care portion 120 of the hydroponic growing system 100 may comprise means for removing ethylene. For example, such ethylene removal means may comprise ethylene scrubbers that comprise dry chemical scrubbers. These machines generally have a pre-filter, a chemisorption bed and an after filter acting so as to remove ethylene from the environment. However, it will be appreciated that any other form of ethylene removal means may be used.

Further, it is important to maintain air-flow around the living organisms. For example, if the roots of a plant are properly oxygenated then the growing capabilities of the plant may be improved. It also helps to maintain a more stable or constant humidity around the root structure and plant thereby reducing the incidence of fungal or bacterial growth which may become prevalent where humidity is not controlled.

In use, a hydroponic growing system 100 comprising a high-care portion 120 may be used to produce crops with little contamination. Seeds for planting and growing in a high-care environment are pre-treated in such a seed pre-treatment area 110. Such pre-treatment may comprise hot water, and optionally UVC treatment. Additionally, the seeds may be agitated. Once treated, the seeds are bagged and sealed. The pre-treatment area 110 may be a substantially sterile environment.

Further, in the pre-treatment area 110, all growing media is treated with UVC, and equipment for use in the high-care facility is treated with UVC to reduce as far as possible the chances of contamination within the high-care portion 120 of the hydroponic growing system 100. Seeds are also treated with hot water.

A plant room 140 provides plant services to each zone, portion and volume of the hydroponic growing facility. In some instances, it will be appreciated that duplicate service systems are used to separately serve low care and high-care portions 150, 120 to avoid contamination of high-care portions 120 from low care portions 150. Plant services may comprise, control boxes, air handling devices to maintain air humidity and temperature, air compression systems, water treatment and pump facilities, and UVC treatment machines, for example and amongst other things.

Once the seeds, the growing media and trays are all pre-treated they are transferred to the high-care portion 120 of the hydroponic growing system 100.

These pre-treatment steps may be undertaken at a location remote from the high-care portion 120 of the system 100, however, it will be appreciated that such pre-treatment zones may be co-located with the high-care portion 120 of the hydroponic growing system 100.

The high-care portion 120 of the hydroponic growing system 100 comprises a seeding area 132, a germination volume 134, a growing volume 136, and a harvesting area 138.

As required, the cleaned seeds are further treated by, for example, UVC radiation immediately prior to arrangement on growing medium in the seeding area 132, the growing medium being located in the trays. The seeds may be continually vibrated by vibrating means comprising, for example, a vibrating plate whilst UVC treated and whist being arranged on the growing medium. The speed of vibration of the plate may be controllable and the speed used will depend on the particular seeds being processed, the size and variety of the seed and the effect of the vibration with the UVC on the seeds.

Once the equipment and seeds have been pre-treated as required, the seeds are arranged on the growing medium within the trays, and the trays may pass through a transfer hatch located between the seeding area 132 and the germination volume 134. The transfer hatch may comprise means for transferring trays between areas and volumes of the system 100 bounded by walls, for example, in a manner consistent with the maintenance of the high-care environment. It will be understood that a number of transfer hatches may be present in the system 100.

The germination volume 134 may comprise racking on which the trays comprising the seeds are placed for a predetermined time. The predetermined time depends on the seed type, the growth cycle and the yield required for any given crop. It will be appreciated that control of the environment in the germination volume 134 may enable the time taken to germinate seeds to be controlled to a certain extent.

The environment in the germination volume 134 may be controlled. For example, the temperature, humidity, air flow and lighting conditions may be controlled either manually or by a suitable control mechanism. The environment in the germination volume 134 may be sensed by a series of sensors and detectors and the environment controlled according to the environment detected by the sensors or detectors. Such control may be carried out remotely by a suitable control utility.

Once germinated, the seeds are moved to the growing volume 136. For example, the growing trays may be placed on moveable racking or may be placed using a pick and place system either robotically or manually. Similarly to the environment of the germination volume 134, the environment of the growing volume 136 may be controlled. The environment in the growing volume 136 may be sensed by a series of sensors and detectors and the environment controlled according to the environment detected by the sensors or detectors. Such control may be carried out remotely by a suitable control utility.

The germinated seeds remain in the growing volume 136 until the crop is deemed ready to harvest. This may be determined visually by operators or may be determined remotely using camera means to view the progress of growth of the crop.

Once deemed ready to harvest, the trays comprising the crops are removed from the growing volume 136 and transferred by any suitable means, robotic or manual, to a harvesting area 138 where the crop is picked, harvested or processed in the appropriate manner for the given crop. Once harvested, the crop may be bagged for onward delivery to direct customers or to commercial retail enterprises.

The dirty trays may be removed from the high-care portion 120 for washing and deep clean before returning to the seeing area 132 to be reseeded with a new crop.

Only once the crop is harvested and bagged will it leave the high-care portion 120 of the hydroponic growing system 100 to the dispatch portion 130.

It will be appreciated that high-care seeding, germinating, harvesting and growing environments reduce contamination during the production of crops in a hydroponic growing system 100.

It will be appreciated that the seeding area 132, the germination volume 134, the growing volume 136 and the harvesting area 138 may be collocated in a single building. However, it will also be appreciated that it is possible to locate the areas and volumes in different locations, however, the high-care environments would need to be controlled in a similar manner across all locations with high-care transfer means implemented between locations.

It will further be appreciated that the seeding area 132, the germination volume, the growing volume and the harvesting area 138 may be located in adjacent rooms of a single building or may be located in a single volume with separately definable volumes as required. In this case, barriers and air locks between the various areas and volumes will be used.

It will be appreciated that the system 100 described above includes many known aspects of high-care treatment. However, it may become possible to apply other treatment regimens or to use other forms of equipment to achieve the result described herein.

Moreover, the system 100 described above may be used to grow a single crop or multiple crops in a single facility. Any crop suitable for growth in a hydroponic growing system 100 may be grown in a high-care portion 120 of such a growing system 100.

Further it will be appreciate that a nutrient rich fluid, provided to the crop(s) may be recycled for reuse. However, the fluid will require filtering and rebalancing to ensure that it is suitable for re-use. Captured drain fluid, through a drainage system is filtered to remove any larger particles, and passed through UV systems to maintain a given level of cleanliness to the fluid. The cleaned fluid is then dosed to optimum levels of nutrients which is required to be reused by the crop(s).

A larger hydroponic growing system, as described above, is disclosed in UK application GB2577973 (Ocado Innovation Limited), hereby incorporated by reference.

As mentioned hereinabove, growth trays may be placed on a rack. Alternatively growth trays may be placed in another form of stacking system, for example, on a frame or rack as previously disclosed in UK application GB1911505.4 “Hydroponics Growing System and Method”. Alternatively, trays may be of a type such as “JFC service trays” as disclosed in co-filed patent application no. GB1918020.7 filed on 9 Dec. 2019 titled STORAGE, GROWING SYSTEMS AND METHODS (Ocado Innovation Limited).

When seeded growth trays or growth trays containing seedlings are placed on a rack lighting and other services or utilities as controlled by a central control means, for example, provision of a fluid nutrient mix, and environmental control for air flow, humidity, temperature and circulation to encourage propagation and or growth of the plants whilst on the rack. As the crop grows, the trays may be rearranged on the rack or the rack may be adapted in order to provide sufficient space for growing.

Thus, the system 100 is able to provide sufficient space and optimised growing conditions for the living organism to grow as it progresses from germination to a mature organism, ready for harvesting.

When the living organisms have grown to maturity the growth tray(s) are transferred to a harvesting area 138, and harvesting the crop. The growth trays may be transferred manually from the stack. Alternatively, a robotic or automated device such as a robotic load handling device suitable for operating with stacked storage systems may be employed to transfer the tray(s).

As noted above, in order to assist with cleaning equipment located within the high-care portion 120, the equipment is preferably raised off the floor, and the amount of equipment and surfaces are minimised.

In one arrangement, in order to assist with maintaining the high-care clean environment, equipment in the high-care portion 120 is reduced or minimised. As described herein, rows of racks and some other equipment are replaced with individual “smart poles” onto which growth trays are placed.

FIGS. 2-7 show one embodiment of a smart pole 400. The smart pole 400 comprises a substantially vertical pole around which a plurality of growth trays 410 may be arranged. As shown in FIG. 7, smart poles 400 may be arranged in rows and up to four stacks of growth trays 410 may be arranged around each pole. Smart poles 400 in the centre of the germination volume 134 or growing volume 136 may have trays 410 arranged two trays 410 side-by-side on opposed sides of the smart poles 400, and smart poles 400 at the edge of the volume may have trays 410 arranged only on one side of the smart poles 400. In this way, rows of stacks of growth trays 410 are created having walk ways or path ways 411 between the rows of stacks of growth trays 410 and each of the trays 410 are accessible to be positioned and relocated as required. The trays 410 may be repositioned manually or by using an automated or semi-automated load handling device. The number of growth trays 410 in each stack may vary in number from a minimum of no growth trays 410 where the specific location is empty to where the smart pole 400 is at full capacity. Further, the number of smart poles 400 may be varied according to need.

Looking now in more detail at the smart poles 400 themselves, the smart poles 400 comprise similar opposed surfaces 412 which fit together to provide a substantially sealed cavity containing utility system or plant services. The opposed surfaces 412 have a number of openings through which utility services may pass. For example, holes or openings for fluid 413 are arranged centrally at regular intervals in the vertical direction, vertically spaced interface positions, along substantially the entire length of the smart pole 400. Corresponding rectangular slots comprising air vents 414 and communication interfaces 450 are spaced apart from the fluid openings 413. The vertical distance between the fluid openings 413, air vents 414 and communication interfaces 450 correspond to the height of a growth tray 410, thereby providing fluid, environmental air control and data transfer means at each level of the smart pole 400. It will be appreciated, that an air vent 414 and a communication interface 450 may be positioned on each side of the fluid openings 413 such that each level has two air vents 414 and two communication interfaces 450, one for each side of the pole 400. In this way, the pole may independently service two growth trays positioned side-by-side at each level. Similarly, the fluid openings 413 may comprise a single opening 413 serving both growth trays, or two openings 413 capable of independently serving each growth tray.

At the upper end, the smart pole 400 is substantially sealed with a cap 415. The cap 415 comprises an interface and communications unit. The cap 415 is in communication with the tray communication interfaces 450, either wirelessly or with a physical connection. The communications unit or cap 415 is placed at the top of the smart pole 400 so that it may have a substantially unobstructed line of sight to a central control system which communicates with the smart pole 400 to control the services provided to each tray 410 placed on or interfaced with the smart pole 400. In this way, the smart pole 400 can control the growing conditions or environment for each of the trays 410 in the system 100.

FIG. 3 shows a deconstructed view of smart pole 400. Front and back opposed surfaces 412 may be seen, and the cap 415 is removed. As may be seen on the back of the opposed surface 412, inside the smart pole 400 there is a fluid pipe 416 extending along the centre of the surface 412 to serve each of the fluid holes 413. Along the outer edge of the smart pole 400 are power rails 417 having inductive coils 418 spaced at regular intervals, corresponding to each level or interface position of the smart pole 418. The smart pole 418 may include various sensors (not shown) in order to monitor the environment and whether a tray 410 is placed on the smart pole 400 at a particular level.

FIGS. 6 (a) and (b) show more detail of the fluid system, particularly the lower end of a smart pole 400 showing the fluid source and drain connections. The fluid holes 413 comprise a fluid source outlet 419 and a fluid drain inlet 420. The outlet 419 and inlet 420 are positioned side-by-side between the air vent 414, and communication interface 450 at each level of the smart pole 400. As noted above, two outlets 419 and two inlets 420 may be provided to independently serve each growth tray positioned side-by-side on one side of the pole 400. Only one set of openings in the pole 400 is shown in the drawings for simplicity. Similarly, the fluid pipe 416 comprises a fluid source pipe 421 and a fluid drain pipe 422. The fluid outlet 419 is in fluid communication with the fluid source pipe 421 and the fluid inlet 420 is in fluid communication with the fluid drain pipe 422. At the bottom of each of the fluid channels 421, 422 there are respective fluid pumps 423, 424. Each of the surfaces 412 may have a fluid source pipe 421 and a fluid drain pipe 422. In other arrangements, the two surfaces 412 may share between them a common fluid source pipe 421 and a fluid drain pipe 422.

In use, the fluid source pump 423 supplies fluid from the fluid supply system on demand to each individual tray 410 on the smart pole 400 as required and determined by the central control system. The fluid drain pump 424 acts as a relay to transmit received fluid run-off to the drain system for recirculating to the fluid supply system once it has been treated and remixed for reuse. In some arrangements, a further interface panel for connecting to and communicating with the central control system may be positioned proximate to the bottom of the smart pole 400, optionally specifically for controlling the pumps 423, 424.

In this way, rather than excess fluid being “waste” the fluid may be reused thereby minimising loss. Further, having an integrated fluid system for both delivery and run-off, the fluid has minimal exposure to contamination hazards whilst circulating in the system before being absorbed by the living organisms during growth.

As has been mentioned above, trays 410 for germinating or growing a crop may be arranged around or on the smart pole 400. FIG. 4 shows one half of a smart pole 400 comprising a single surface 412 having a number of trays 410 placed thereon, and FIG. 5 shows a section through the smart pole and tray 410. As can be seen, each tray 410 corresponds to an interface level of the smart pole 400 and corner of the tray 410 aligns with a fluid inlet/outlet 413 and an induction coil 418. At each level, two trays 410 are positioned side-by-side creating two stacks. The trays are separated by supportive legs located at each corner that is not otherwise supported by the smart pole 400. The trays 410 may be provided with power through the inductive coil 418 and a corresponding inductive coil on the tray. The lower surface of the trays 410 comprises a light source 425, thus, within a stack of trays 410 each of the growth surfaces 426 may be provided with light for growing a crop and the light provided to the crop may be controlled by the central control system. As can be seen in FIG. 4, the fluid source outlet 419 connects directly to a fluid inlet in the rim of the tray 410, and the light source 425 is located below the growth surface separated by a drainage level of the tray 410. It will be appreciated that any suitable power means and transmission means may be used.

In this way, each growth tray 410 may be provided with the services and utilities to optimise the growing environment for the particular crop at any stage during its growth cycle, and thereby optimise the yield of the crop and efficiency of the system 100.

Smart poles 400 such as the ones described herein, may be mounted directly in the floor of a hydroponic growing system 100. In this way, the smart pole 400 is able to provide services and utilities directly to the growth trays 410 and surrounding assets are kept to a minimum. This reduces the costs in setting up the system. Further, the reduced need for exposed equipment in the high-care portion 120 thereby reducing the number of surfaces requiring cleaning to maintain the environment.

FIGS. 8-15 show an alternative embodiment of a smart pole 401 having an alternative arrangement with a central support structure 433 and base support 437. Similarly to the embodiment of FIGS. 2-7, the smart pole 401 comprises a substantially vertical pole around which a plurality of growth trays 410 may be arranged.

FIG. 12, shows part of a deconstructed smart pole 401. The smart pole 401 comprises two opposed surfaces 430 which fit together to provide a substantially sealed cavity. The opposed surfaces 430 have a number of openings through which utility services may pass. For example, as before, holes or openings for fluid 431 are arranged centrally at regular intervals in the vertical direction along substantially the entire length of the smart pole 401. Corresponding rectangular slots comprising air vents 432 and communication interfaces 451 are spaced apart from, and on each side of, the fluid openings 431. In this embodiment, rather than separate inlet and outlets 419, 420 there is a single opening 431 acting an inlet to the trays 410 from the smart pole 401 because, as will be discussed in more detail below, run-off fluid is drained through down-pipes in the stack of trays 410, to a base 437 of the smart pole 401.

FIG. 9 shows the smart pole 401 together with a deconstructed view of the base 437 comprising connections 444 and connecting members which assist in ensuring stability of the smart pole 401. FIG. 8 shows an assembled view of the smart pole 401 and base 437.

FIG. 11 shows the fluid connection 436. A source fluid channel 434 is provided around the base of the central support 433 and extends up, substantially vertically, along the length of the central support 433. As may be seen in FIG. 10, which shows the lower section of a partially assembled base 437 and pole 401, the fluid connections 436 extend through the pole to the fluid source pipe 434. The fluid source pipe is encased by a member forming part of the base 437. A source fluid pump 438 is provided to, in use, pump fluid from the base 437 up the support 433 to trays 410 supported by the smart pole 401.

In use, growth trays 410 for germinating, propagating or growing a crop may be arranged around or on the smart pole 401. FIG. 13 shows a section through a smart pole 401, and tray 410. As can be seen, the fluid source connects directly to a rim of the tray 410 in order to flood the growth surface 439 with nutrient rich fluid. The growth tray is inclined towards down-pipes 440 provided through the support legs. At the bottom of the stack, the tray leg may be located in locating member 441, shown in FIG. 10, which funnels run-off fluid into a connecting member 442 that conducts the run-off fluid through the base 437 to the bottom of the pole 401 to connect with the drain pipe 435.

Power connections 444 are provided through the base 437, and continue to each of the trays 410 through power connections arranged on the support 433. Power may be used, for example, for light sources on the bottom of the trays 410 and communication means such as the communication interfaces. In particular, power may be used for sensors located in the pole for monitoring growth tray conditions, and to run fluid pumps, and or for receiving data from sensors that may be embedded in the growth tray. Any suitable power means and transmission means may be used.

Smart poles 401 such as the ones described herein, may be placed directly in the floor of a hydroponic growing system 100, or the floor may be specifically designed to receive smart poles 401. As with smart pole 400, smart pole 401 is able to provide services and utilities directly to the growth trays 410 and surrounding assets are kept to a minimum. This reduces the costs in setting up the system. Further, the pole system 400, 401 reduces need for and amount of exposed equipment in the high-care portion 120 thereby reducing the number of surfaces requiring cleaning to maintain the environment.

As shown in FIGS. 14 and 15, smart poles 401 may be arranged in rows and up to four stacks of growth trays 410 may be arranged around each pole. Smart poles 401 in the centre of the germination volume 134 or growing volume 136 may have trays 410 arranged two trays 410 side-by-side on opposed sides of the smart poles 401, and smart poles 401 at the edge of the volume may have trays 410 arranged only on one side of the smart poles 401. In this way, rows of stacks of growth trays 410 are created having walk ways or path ways 411 between the rows of stacks of growth trays 410 and each of the trays 410 are accessible to be positioned and relocated as required. The trays 410 may be repositioned manually or by using an automated or semi-automated load handling device. The number of growth trays 410 in each stack may vary in number from a minimum of no growth trays 410 where the specific location is empty to where the smart pole 401 is at full capacity. Further, the number of smart poles 401 may be varied according to need.

As shown in FIG. 14, trays 410 are racked closer together in the vertical direction near the top of the poles 401 compared with the bottom of the poles 401. For example, the growth trays 410 which are closer together may contain germinating or juvenile plants, whereas growth trays 410 more spaced nearer the bottom of the poles 401 may contain larger plants which are closer to maturity. Growth trays 410 may be repositioned at an appropriate location as the living organisms contained within progress through their life-cycle.

For all embodiments of the smart poles 400, 401 described herein, it will be appreciated that smart poles may be added to a facility to increase capacity of the facility as required. Services and utilities may be linked (in parallel or in series) between smart poles 400, 401, to “daisy-chain” services and utilities, in series or in parallel, throughout the facility as additional smart poles 400, 401 are added. The services and utilities may be routed through the floor, for example.

It will be appreciated that the features described hereinabove in connection with specific embodiments may alternatively all be used together in a single embodiment smart pole. In other embodiments of the invention, some of the features may be omitted. The features described herein may be used in any compatible arrangement.

The hydroponic growing system described above with reference to the figures allows control of the growing environment and thus reduces the risk of microbiological contamination. In addition, the modular nature of the system allows for efficient use of space and ready scalability. The number of pole structures can be chosen to fit the available space and size of growth trays. Accordingly crop yields and growing times are improved, contamination is minimised, shelf-life is improved and the environmental impact is minimised.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

1. A pole system for racking, storing, germinating, propagating and growing living organisms on a growth tray, the pole comprising:
a substantially vertical support structure, the support structure including at least one utility system for supporting propagation or growth of a living organism;
one or more vertically-spaced interface position(s), each for interfacing with a growth tray; and
one or more openings in the support structure, corresponding to one or more of the interface positions, for providing services to interfaced growth tray(s).

2. A pole system according to claim 1, wherein the at least one utility system comprises
one or more of: a fluid delivery system; a fluid drain system; a fluid recirculation system; an air control system; a temperature control system; a power system; and/or a control system.

3. A pole system according to claim 1, wherein a control system comprises one or more of:
communication interface(s) for relaying data to and from the pole system;
a central control system in communication with the pole system for managing conditions of a growth tray interfaced with the pole system;
inductive coils corresponding to interface position(s) for relaying power and control signals to a growth tray interfaced with the pole system; and/or
sensors corresponding to the interface positions for sensing the presence of a growth tray interfaced with the pole system, and monitoring conditions of a growth tray interfaced with the pole system.

4. A pole system according to claim 1, wherein a fluid delivery system comprises:
at least one fluid delivery pump for pumping fluid to each of the interface positions via a pipe extending substantially vertically up the support structure; and
the one or more openings comprise,
a fluid outlet for delivering fluid to an interfaced tray.

5. A pole system according to claim 1, wherein a fluid drain system comprises:
a pipe extending substantially vertically down the support structure for receiving fluid run-off from growth tray(s) interfaced with the pole system via an opening in the support structure including a fluid inlet; and
at least one fluid drain pump for relaying fluid run-off to a fluid recirculating system.

6. A pole system according to claim 4, wherein at least one of the one or more openings in the support structure comprises: of an air vent air control system for circulating humid and temperature controlled air to interfaced growth tray(s).

7. A pole system according to claim 1, wherein a communication interface comprises:
an end cap for inserting in an uppermost end of the support structure located proximal to a base of the support structure.

8. A pole system according to claim 1, wherein configured to be the support structure inserted in a facility floor.

9. A pole system according to claim 1, comprising:
a base support including:
a frame extending radially from a lower end of the support structure to provide stability to the support structure and having at least one drainage channel for conducting run-off from growth tray(s) interfaced with the pole system to a fluid recirculation system.

10. A pole system according to claim 9, wherein the base support comprises:
a locating member, for locating an interfaced growth tray.

11. A pole system according to claim 9, wherein the base support comprises:
fluid, drain or power connections.

12. A pole system according to claim 1, wherein growth tray(s) for use with the pole system comprise:
a fluid inlet for receiving fluid from the pole system and delivering fluid to a growing surface: and
a fluid outlet for delivering fluid run-off to the pole drain system.

13. A pole system according to claim 12, configured to include a stack of growth trays to be interfaced with the pole system, and wherein the growth trays comprise:
support legs at least at each corner.

14. A pole system according to claim 13, wherein the bottom-most support leg in a stack locates in a locating member and the support legs each comprise:
a down-pipe for transmitting run-off from above-stacked growth trays.

15. A pole system according to claim 1, wherein growth tray(s) are configured to receive power from the pole system for illuminating lights arranged on a lower face of the growth tray(s).

16. A pole system according to claim 1, wherein each growth tray comprises:
identification means.

17. A pole system according to claim 1, configured for up to four growth trays to be arranged around the pole system and interface with the pole system at each vertically-spaced level.

18. A hydroponic system for racking, storing, propagating and growing living organisms on a growth tray(s) arranged around pole system(s) according to claim 1, wherein the pole systems are arranged in a high-care portion of the hydroponic system.

19. A hydroponic system according to claim 18, wherein the high-care portion of the hydroponic system is substantially closed.

20. A hydroponic system according to claim 18, wherein the pole systems are arranged in rows providing pathways therebetween.

21. A hydroponic system according to claim 18, configured for trays may be moved within the system manually or using one or more automated load handling device.

22. A method of producing a crop having reduced or substantially negligible Pyrrolizidine Alkaloids, PAs, wherein the crop is provided with services via a smart pole system according to claim 1, wherein the pole system includes:
a substantially vertical support structure, the support structure including at least one utility system for supporting propagation or growth of a living organism;
one or more vertically-spaced interface position(s), each for interfacing with a growth tray;
one or more openings in the support structure, corresponding to one or more of the interface positions, for providing services to interfaced growth tray(s) the method comprises:
germinating, propagating or growing a crop in a high-care portion of a hydroponic system.
